(19) United States
(12) Patent Application Publication
(10) Pub. No.: US 2024/0353225 A1
(43) Pub. Date: Oct. 24, 2024

(54) METHOD AND DEVICE FOR DETERMINING AND CHARACTERIZING ROAD UNEVENNESS

(71) Applicant: Robert Bosch GmbH, Stuttgart (DE)

(72) Inventors: Devi Raj Sunkara, Bangalore, Karnataka (IN); Andreas Hoffmann, Obersulm (DE); Jan Scheuing, Vellberg (DE)

(21) Appl. No.: 18/683,598

(22) PCT Filed: Aug. 9, 2022
(86) PCT No.: PCT/EP2022/072374

§ 371 Date: Feb. 14, 2024

(30) Foreign Application Priority Data
Aug. 19, 2021 (DE) 10 2021 209 136.9

(51) Int. Cl. G01C 7/04

(52) U.S. Cl. CPC G01C 7/04

(57) ABSTRACT

A method for determining and characterizing road unevenness of a roadway. Sensor data are generated by at least one wheel speed sensor and/or at least one wheel-individual acceleration sensor of a motor vehicle travelling the roadway. The road unevenness is determined and characterized by an arithmetic unit using the sensor data generated, thereby determining an edge type of the road unevenness.

### FIELD

The present invention relates to a method and a device for determining and characterizing road unevenness.

### BACKGROUND INFORMATION

Road unevenness, for example in the form of potholes, occur often and represent a safety risk for motor vehicles. How great the safety risk is, depends mainly on the shape and size of the road unevenness. Bicyclists are considered a particularly vulnerable group. In addition, road unevenness also causes inconveniences for the drivers and passengers in the motor vehicles. However, reliable and region-specific data about the presence and type of such road unevenness do not exist. Creating hazard maps is described, for example, in German Patent Application No. DE 10 2010 055 370 A1.

Sensor data from lidar, radar, or camera sensors can be used to detect, estimate, and map road unevenness. Detection and estimation methods are used to detect road damages, wherein the methods can comprise machine learning algorithms which obtain image and video data as input.

However, the sensors used in this case often do not fulfill the ASIL-D standard (Automotive Safety Integration Level-D). Furthermore, the proportion of motor vehicles equipped with such sensors is rather low.

Furthermore, machine learning algorithms for detecting and estimating potholes are susceptible to false positive and false negative results. In addition, the algorithms consume considerable computing time resources.

The risk potential of a ground unevenness also depends in particular on the shape and size of the ground unevenness. For example, potholes with sharply falling edges can generally lead to greater damages to the motor vehicle. On the other hand, with relatively smooth transitions, the risk potential is lower. There is therefore a need to not only detect ground unevenness but also to classify them more precisely.

### SUMMARY

The present invention provides a method and a device for determining and characterizing road unevenness. Preferred embodiments of the present invention are disclosed herein.

According to a first aspect, the present invention relates to a method for determining and characterizing road unevenness of a roadway. According to an example embodiment of the present invention, sensor data are generated by at least one wheel speed sensor and/or at least one wheel-individual acceleration sensor of a motor vehicle travelling the roadway. The road unevenness is determined and characterized by an arithmetic unit using the sensor data generated. Characterizing the road unevenness comprises determining an edge shape of the road unevenness.

According to a second aspect, the present invention relates to a device for determining and characterizing road unevenness of a roadway, with an interface and an arithmetic unit. The interface is designed to receive generated sensor data from at least one wheel speed sensor and/or at least one wheel-specific acceleration sensor of a motor vehicle driving on the roadway. The arithmetic unit is designed to determine the road unevenness using the generated sensor data. Characterizing the road unevenness comprises determining an edge shape of the road unevenness.

The present invention makes it possible to detect and analyze the occurrence and the severity or the extent of road unevenness in that the edge shapes of the road unevenness are in particular detected. The present invention can furthermore contribute to creating a comprehensive database of road unevenness.

Modern motor vehicles have a plurality of sensors whose data are used by embedded systems or motor vehicle computers for safety and comfort reasons. Wheel speed sensors belong to the most frequently used sensors.

High-frequency wheel speed sensors provide information about the exact state of the wheel. These sensors also belong to the few sensors that fulfill the ASIL-D standard, such that they are very reliable in comparison to other sensors.

Furthermore, wheel speed sensors are also very widespread. In addition, the wheel speed sensors are the sensors that are closest to the roadway since they are attached directly to the wheel. This results in high reliability due to the proximity of the sensors to the road surface.

Furthermore, wheel-specific acceleration sensors are increasingly provided. In contrast to vehicle-fixed inertial sensors, which are not arranged on movable parts of the motor vehicle, the wheel-specific acceleration sensors move with the wheels. As a result, the precise instantaneous acceleration for each individual wheel can be detected.

Specifically, a combination of wheel speed sensor and acceleration sensor on the wheel is also advantageous.

The motor vehicle can be a two-wheeler, three-wheeler, a passenger car, truck, motorcycle, or similar. The motor vehicle can, for example, also be an aircraft, for example in order to detect damage to a runway.

The term “determining the road unevenness” can in particular be understood to mean that the presence of road unevenness is detected. The term “characterizing” can in addition be understood to mean that additional properties (beyond the mere presence) are determined. In doing so, the edge shape of the road unevenness is in particular determined.

The term “edge shape” of the road unevenness is understood to mean the shape of an edge of the road unevenness, wherein the edge can be an edge occurring when driving onto the road unevenness and/or an edge occurring when leaving the road unevenness. The edge can thus be a contact region of the road unevenness with the roadway. Possible edge shapes may, for example, include steep edges, rounded edges, or ramp-shaped (angled) edges.

The edge shape can be described by the slope (steepness) relative to the roadway. The slope can be described by an angle between the roadway and the road unevenness. The steeper the edge falls relative to the roadway, the higher is the risk of damages to the motor vehicle.

Within the scope of the present invention, road unevenness can comprise road damages, e.g., potholes, depressions, or elevations, ruts, but also intentional road unevenness, e.g., speed bumps, ramps, and similar.

The arithmetic unit is preferably located close to the data source or the sensor system, for example integrated in a control apparatus of a brake control system, in order to be able to process the sensor values as unfiltered as possible.

According to a further embodiment of the method of the present invention for determining and characterizing road unevenness, the wheel speed sensor senses pulses, for example by means of a Hall sensor, as a function of a movement of a pulse wheel arranged on a wheel of the motor vehicle. The arithmetic unit determines an angular profile of a high-frequency wheel speed on the basis of changes in the sensed pulses as a function of time, that is to say on the basis of the raw signals of the alternating magnetic fields (north/south) originating from the pulse wheel. The term “angular profile of the wheel speed” is understood to mean the change in the wheel speed as a function of the angle. This can take place by determining the time difference between the individual pulses. The arithmetic unit detects the edge shape of the road unevenness on the basis of the determined angular profile of the wheel speed. In this manner, road unevenness usually leads to a short-term change in the wheel speed since the wheel of the motor vehicle is accelerated or slowed when driving onto the road unevenness. The same applies when leaving the road unevenness. By detecting this change in the wheel speed, the arithmetic unit can determine the road unevenness and, in addition, also the edge shape. In particular, differently steep edges are characterized by different characteristic angular profiles of the wheel speed. As a result, the edge shape can be determined by evaluating the angular profile.

In comparison with a time profile of the wheel speed, the angular profile, which results from the pulse changes over time, offers significant advantages with regard to precision of small changes in the roadway surface condition. For example, it may be provided to determine the number of pulses in a time period of a specified duration, for example of less than or equal to 1 ms. Processing the raw sensor signals in the arithmetic unit makes it possible to detect and precisely measure even slight changes in the roadway surface condition.

According to a further embodiment of the method of the present invention for determining and characterizing road unevenness, the arithmetic unit determines road unevenness if a magnitude of an angular change in the wheel speed exceeds a first threshold value. The threshold value may depend on a motor vehicle speed. Furthermore, the arithmetic unit determines the edge shape by comparing the magnitude of the angular change in the wheel speed to at least a second threshold value, wherein the at least second threshold value is greater than the first threshold value. For example, it can be provided to distinguish between n different edge shapes, wherein n is a natural number. A total of n threshold values, including the first threshold value, are then provided. For example, a distinction is to be made between a sharp (steep) edge, a rounded edge, and a ramp-shaped edge. If the magnitude of the angular change in the wheel speed exceeds the first threshold value but is smaller than a second threshold value, it is detected that an edge is present, and this edge is characterized as a rounded edge. If the magnitude of the angular change in the wheel speed exceeds the second threshold value but is smaller than a third threshold value, it is detected that the edge is a ramp-shaped edge. Lastly, if the magnitude of the angular change in the wheel speed exceeds the third threshold value, it is detected that the edge is a sharp edge.

According to a further embodiment of the method of the present invention for determining and characterizing road unevenness, the sensor data of the at least one wheel-specific acceleration sensor comprise a vertical acceleration of the respective wheel along a vertical axis of the motor vehicle, wherein the arithmetic unit determines the edge shape of the road unevenness as a function of a time profile of the vertical acceleration. The greater the vertical acceleration, the steeper the edge generally falls.

According to a further embodiment of the method of the present invention for determining and characterizing road unevenness, a road unevenness is determined if a magnitude of the vertical acceleration exceeds a first threshold value, and the edge shape is determined by comparing the magnitude of the vertical acceleration to at least a second threshold value. Analogously to the case of the magnitude of the angular change in the wheel speed, n edge shapes can again be distinguished, wherein a total of n threshold values, including the first threshold value, are defined.

According to a further embodiment of the method of the present invention for determining and characterizing road unevenness, the arithmetic unit calculates a frequency behavior of the wheel speed and/or a vertical acceleration of the wheel of the motor vehicle on the basis of the sensor data generated by the wheel speed sensor, wherein the arithmetic unit determines the road unevenness on the basis of the calculated frequency behavior of the wheel speed and/or the vertical acceleration. A road unevenness can thus be determined if at least one specified frequency occurs in the frequency behavior. The frequency behavior can also be compared to specified frequency patterns in order to determine a road unevenness and determine the edge shape.

According to a further embodiment of the method of the present invention for determining and characterizing road unevenness, the arithmetic unit furthermore determines a type and/or property of the road unevenness on the basis of the sensor data. A type of the road unevenness can, for example, be a pothole, a depression, an elevation, a speed bump, ramp, or similar. The term “property of the road unevenness” can be understood to mean a spatial extent, e.g., a depth, width, and length of a pothole.

According to a further embodiment of the method of the present invention for determining and characterizing road unevenness, characterizing the road unevenness comprises determining a depth and/or height (e.g., in centimeters) of the road unevenness on the basis of an amplitude of a change in the wheel speed and/or vertical acceleration. The amplitude of the high-frequency wheel speed and/or vertical acceleration changing at this moment corresponds to the depth or height of a road unevenness.

According to a further embodiment of the method of the present invention for determining and characterizing road unevenness, the wheel speed sensor senses pulses as a function of a movement of a pulse wheel arranged on a wheel of the motor vehicle, wherein characterizing the road unevenness comprises determining a length of the road unevenness on the basis of a number of changes in the pulses in the time period between driving onto and leaving the road unevenness.

According to a further embodiment of the method of the present invention for determining and characterizing road unevenness, determining the road unevenness comprises determining a position of the road unevenness relative to a reference point of the motor vehicle on the basis of a determined cornering and/or individual wheel evaluation. The width of the road unevenness can thereby be determined.

According to a further embodiment of the method of the present invention for determining and characterizing road unevenness, frequency patterns of the wheel speed amplitudes and the number of pulse changes in a particular time period can be stored for various edge shapes of the road unevenness, which frequency patterns are, for example, generated during test drives under specified conditions. By comparing the instantaneous determined frequency pattern or amplitude fluctuation to the stored frequency patterns, the edge shape of the road unevenness can then be determined.

According to a further embodiment of the method of the present invention for determining and characterizing road unevenness, the depth of the road unevenness, e.g., of a pothole, can be determined by considering the amplitude of the gradient, i.e., the temporal change in the wheel speed. The greater the amplitude, the deeper the pothole. On the basis of a specified dependency, e.g., a look-up table, the depth of the road unevenness can be determined on the basis of the temporal change in the wheel speed. In this case, further parameters, e.g., the instantaneous speed of the motor vehicle, can also be taken into account.

According to a further embodiment of the method of the present invention for determining and characterizing road unevenness, the arithmetic unit further determines and/or characterizes the road unevenness by taking into account a driving situation and/or a driver event. The driver event may, for example, be a braking event, acceleration event, or steering event. In the driving situation, the instantaneous speed of the motor vehicle can be taken into account, for example.

False positive detections can be reduced on the basis of the driving situation or the driver event in that, for example, in the event of a rapid acceleration or deceleration, threshold values for detecting the ground unevenness are increased in order to prevent a ground unevenness from being detected as a result of the acceleration or deceleration itself.

On the basis of the driving situation or the driver event, it is however also possible to detect that a road unevenness is to be expected. For example, if the driver detects a pothole, the driver usually brakes so that the presence of a braking event can, for example, be used to make the detected ground unevenness plausible. For example, a probability of the presence of a particular ground unevenness can be calculated. This probability is increased when a braking event is present.

According to a further embodiment of the method of the present invention for determining and characterizing road unevenness, the arithmetic unit determines the edge shape of the road unevenness using a machine learning model and/or statistical model which receives input data dependent on the sensor data.

The input data can, for example, be the sensor data themselves. However, the sensor data can also first be preprocessed before they are provided to the machine learning model and/or statistical model.

The machine learning model can be trained in advance on the basis of training data. According to one embodiment of the present invention, it can be provided that the machine learning model determines and/or characterizes ground unevenness in real time during operation.

According to a further embodiment of the method of the present invention for determining and characterizing road unevenness, the machine learning model obtains a time profile of at least one wheel speed and/or a frequency behavior of the wheel speed as input values. The machine learning model outputs a variable which corresponds to a probability of the presence of a ground unevenness. The machine learning model can also be trained to classify various types and/or properties of ground unevenness. For example, the machine learning model can determine the edge shape. For this purpose, for example, an edge shape can be determined from a specified set of edge shapes (e.g., sharp edge, round edge, ramp). The edge shape can also be determined as a continuous parameter, for example between 0 and 1, wherein 0 corresponds to a flat transition (round edge), and 1 corresponds to a steep edge (e.g., a vertical drop).

According to a further embodiment of the method of the present invention for determining and characterizing road unevenness, the machine learning model obtains both sensor data of the at least one-wheel speed sensor and sensor data of the at least one wheel-specific acceleration sensor as input data. These data can be specified in parallel or are merged before inputting them into the machine learning model.

According to a further embodiment of the method of the present invention for determining and characterizing road unevenness, two machine learning models are provided, wherein a first machine learning model determines the edge shape of the road unevenness on the basis of the sensor data of the at least one wheel speed sensor, and a second machine learning model determines the edge shape of the road unevenness on the basis of the sensor data of the at least one wheel-specific acceleration sensor. The outputs of the first machine learning model and of the second machine learning model can subsequently be merged in order to ultimately determine the edge shape of the road unevenness. The accuracy can be improved by combining different sensor data.

According to a further embodiment of the method of the present invention for determining and characterizing road unevenness, the arithmetic unit is an external arithmetic unit, i.e., it is arranged outside the motor vehicle. For example, the evaluation may take place in a cloud. The sensor data can in this case be output to the arithmetic unit via an interface of the motor vehicle.

According to a further embodiment of the method of the present invention for determining and characterizing road unevenness, the arithmetic unit is an internal arithmetic unit, i.e., it is arranged in the motor vehicle. For example, the arithmetic unit is a control unit of the motor vehicle or a subsystem of the motor vehicle. For example, the arithmetic unit may be the control unit of an anti-lock brake system of the motor vehicle.

According to a further embodiment of the present invention, the determination and/or characterization of road unevenness is implemented at the edge of a computer network (edge computing), wherein the computer network comprises any combination of electronic control units, motor vehicle computers, connection control units, and clouds. In this combination, the vehicle position is then also available as information. Together with the detected road unevenness, this can then also be mapped.

According to a further embodiment of the method of the present invention for determining and characterizing road unevenness, information is output via a display unit of the motor vehicle to a driver of the motor vehicle when road damages are detected. In particular, the information can comprise the occurrence of the road unevenness and/or details regarding the road unevenness, e.g., a type and/or property of the road unevenness.

According to a further embodiment of the method of the present invention for determining and characterizing road unevenness, the arithmetic unit can compare the sensor data of different wheel speed sensors and/or wheel-specific acceleration sensors of different wheels to one another. If a change in the wheel speed or acceleration, for example, occurs only in the wheel speed sensors and/or wheel-specific acceleration sensors on one side of the motor vehicle, the arithmetic unit can determine that the road unevenness is located in the region of the corresponding side of the motor vehicle. The arithmetic unit can then detect a pothole, for example.

If a change in the wheel speed or acceleration occurs in the wheel speed sensors and/or wheel-specific acceleration sensors on both sides of the motor vehicle, the arithmetic unit can determine that the road unevenness is extensive. The arithmetic unit can then detect a speed bump, for example.

According to a further embodiment of the method of the present invention for determining and characterizing road unevenness, the arithmetic unit can also take into account the steering angle of the motor vehicle. If the motor vehicle drives through a curve, the steering angle thus exceeds a specified threshold value, and if the arithmetic unit determines that only one of the wheel speed sensors and/or wheel-specific acceleration sensors of the wheels measures a significant change in the wheel speed or acceleration above a threshold value, the arithmetic unit can detect a pothole. In this case, it is to be expected that, on the basis of the steering angle, only one wheel of the motor vehicle drives through the pothole. In the case of an extensive road unevenness, a plurality of wheels will measure a significant change in the wheel speed or acceleration above a threshold value.

According to a further embodiment of the method of the present invention for determining and characterizing road unevenness, the arithmetic unit calculates a length of the road unevenness on the basis of the sensor data. Thus, on the basis of a first change in the wheel speed and/or acceleration, the arithmetic unit can detect driving onto the road unevenness and, on the basis of a second change in the wheel speed and/or acceleration, the arithmetic unit can detect leaving the road unevenness. By taking into account the vehicle speed, the arithmetic unit can determine the length of the road unevenness. The number of pulse changes between the time of driving onto the road unevenness and leaving it corresponds to the length, e.g., in centimeters.

According to a further embodiment of the method of the present invention for determining and characterizing road unevenness, the arithmetic unit calculates an averaged wheel speed by averaging the wheel speed over a specified time period. The arithmetic unit determines a road unevenness if a deviation of an instantaneous wheel speed from the averaged wheel speed exceeds a threshold value.

According to a further embodiment of the method of the present invention for determining and characterizing road unevenness, the arithmetic unit determines the presence of the ground unevenness by taking into account the sensor data of further sensors, e.g., video sensors, lidar sensors, radar sensors, and similar. In particular, the arithmetic unit can make the presence of the ground unevenness plausible on the basis of the additional sensor data. A type and/or property of the ground unevenness can thus be determined on the basis of video data by means of object detection methods.

According to a further embodiment of the method of the present invention for determining and characterizing road unevenness, at least one threshold value for determining and/or characterizing the road unevenness can be adjustable. For this purpose, an interface can be provided, for example through bidirectional communication between the motor vehicle and a cloud.

According to a further embodiment of the method of the present invention for determining and characterizing road unevenness, the data regarding the road unevenness are merged for generating a geographical map. In particular, the road unevenness and optionally the type and/or property of the road unevenness can be noted on a road map. The generation of the geographical map can take place using statistics-based and/or machine-learning-based algorithms in a cloud. The geographical map can be updated dynamically.

According to a further embodiment of the method of the present invention for determining and characterizing road unevenness, the sensor data from internal or external acceleration sensors can be used to detect vibrations in three dimensions. By means of statistical methods or machine learning models, road unevenness can be detected.

### BRIEF DESCRIPTION OF THE DRAWINGS

FIG. 1 shows a schematic block diagram of a device for determining and characterizing road unevenness according to one example embodiment of the present invention.

FIG. 2 shows a schematic block diagram of a motor vehicle with a device according to an example embodiment of the present invention for determining and characterizing road unevenness.

FIG. 3 shows a schematic representation for explaining the change in the wheel speed when driving over ground unevenness.

FIG. 4 shows schematic profiles of wheel speeds and accelerations for various edge shapes.

FIG. 5 shows a flow chart of a method for determining and characterizing road unevenness according to one example embodiment of the present invention.

### DETAILED DESCRIPTION OF EXAMPLE EMBODIMENTS

In all figures, identical or functionally identical elements and devices are provided with the same reference signs. The numbering of method steps serves the purpose of clarity and is generally not intended to imply a specific chronological order. In particular, a plurality of method steps can be carried out simultaneously.

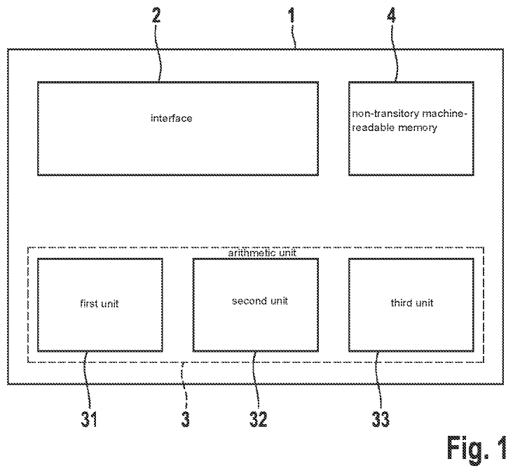

FIG. 1 shows a schematic block diagram of a device 1 for determining and characterizing road unevenness. The device 1 comprises an interface 2, which is coupled, for example, via a motor vehicle communication bus to at least one wheel speed sensor and/or at least one wheel-specific acceleration sensor. The device 1 can furthermore be connected to various internal sensors of a brake system of the motor vehicle. In addition, sensors external to the system can also be connected, for example via the motor vehicle communication bus.

The interface 2 may also be a wireless connection in order to be coupled to the motor vehicle. The device 1 can thus either be arranged in the motor vehicle or be an external device.

The device 1 furthermore comprises a arithmetic unit 3 which determines and characterizes road unevenness on the basis of the sensor data received via the interface 2. The arithmetic unit 3 can comprise one or more electronic processors, e.g., a programmable microprocessor, microcontroller, or similar. Furthermore, the device 1 comprises a non-transitory machine-readable memory 4 in order to store the received sensor data. The arithmetic unit 3 can read and write into the memory 4.

The arithmetic unit 3 can comprise a first unit 31 for data acquisition, a second unit 32 for preprocessing the sensor data, and a third unit 33 for determining the road unevenness. The first to third units 31 to 33 can be designed as separate electronic processors or can also be implemented by the same electronic processor or a combination of electronic processors.

In the phase of data acquisition, the device 1 acquires the signals from the at least one sensor almost in real time. The data received from the at least one sensor are in the raw format, such as speed pulses from the wheel speed sensors or vertical accelerations of the wheels of the vehicle from the wheel-specific acceleration sensors. These signals are acquired via the interface 2 and are, for example, written into the memory 4 by the first unit 31.

In the preprocessing phase, the raw sensor data are cleaned up and processed by the second unit 32 in order to calculate high-frequency wheel speed data.

In the phase of calculating the model algorithm, the high-frequency wheel speed data are used by the third unit 33 in order to detect the road unevenness. The third unit 33 can distinguish the road roughness of potholes and rough roads, for example on the basis of finely calibrated threshold values of a model. In addition, the type and/or property of the road unevenness can be detected. In particular, depth and/or length and/or width of the road unevenness are detected and output. The third unit 33 furthermore detects the edge shape of the road unevenness, for example on the basis of a profile of the wheel speed. Alternatively or additionally, for detecting the edge shape of the road unevenness, the third unit 33 can take into account a profile of the vertical acceleration of the wheel or of the wheels.

The information can be output via the interface 2, for example to further arithmetic units of the motor vehicle or to an external cloud.

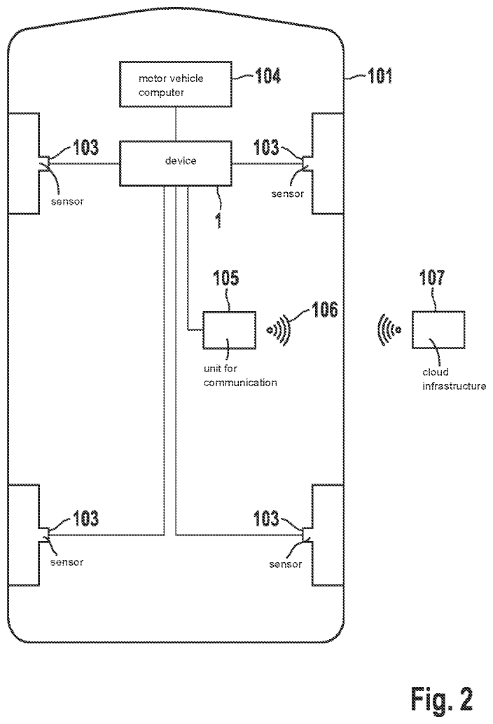

FIG. 2 shows a schematic block diagram of a motor vehicle 101 with a device 1 described in FIG. 1 for determining and characterizing road unevenness. Arranged on each wheel of the motor vehicle 101 is a wheel speed sensor and/or wheel-specific acceleration sensor 103, which is permanently wired or alternatively connected via the motor vehicle bus to the device 1 and a motor vehicle computer 104. The device 1 may be an electronic control apparatus of the motor vehicle 101.

Using the information received from the wheel speed sensors and/or wheel-specific acceleration sensors 103, the device 1 determines a motor vehicle speed, a kilometer reading, a slip, etc. Furthermore, the device 1 determines the road unevenness as well as the edge shape of the road unevenness as described above.

Alternatively, the motor vehicle computer 104 can also be designed to determine and characterize the road unevenness.

The information regarding the road unevenness can be transmitted further via a communication bus of the motor vehicle 101 to a unit 105 for communication with other motor vehicles or other external devices (V2X unit). This unit 105 can store the information and/or transmit it to a cloud infrastructure 107 via a wireless communication channel 106. The wireless communication channel 206 may, for example, comprise a mobile radio network, a Wi-Fi interface, a Bluetooth interface, etc.

The data can then be managed, cleaned up, processed, and visualized in the cloud infrastructure 107. The data can be further processed, for example, in order to create a geographical map on which the information about the road unevenness is visualized. A table or a report of potholes and road unevenness can also be generated.

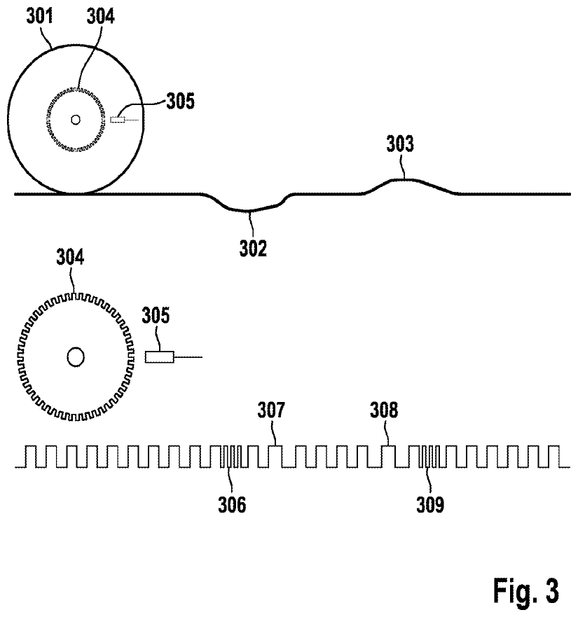

FIG. 3 shows a schematic representation for explaining the change in the wheel speed when a motor vehicle drives over ground unevenness 302, 303. A wheel speed sensor determines the wheel speed of the wheel 301 by means of the incremental encoder principle.

A sensor element 305 of the wheel speed sensor, e.g., a Hall sensor, an anisotropic-magnetoresistive-effect (AMR) sensor, a giant magnetoresistive (GMR) sensor, or similar, is exposed to the changing magnetic field of a rotating encoder 304, which is mounted on an axis of the wheel 301.

The sensed changes in the magnetic flux are transmitted as speed pulses to the arithmetic unit 1. The arithmetic unit 1 measures the time differences between adjacent speed pulses and calculates therefrom (together with further calibration parameters, e.g., the number of pulses per revolution and the wheel circumference) the instantaneous high-frequency wheel speed.

When driving into and leaving a pothole 302 or a speed bump 303, a sudden deviation of the instantaneous high-frequency wheel speed occurs. This is due to the fact that, when driving into the pothole 302, the wheel 301 experiences a sudden increase 306 in the wheel speed. Conversely, when leaving the pothole 302, the wheel 301 experiences a sudden decrease 307 in the speed.

In the case of the speed bump 303, the situation is reversed, that is to say the wheel 301 experiences a sudden decrease 308 in the wheel speed when driving onto the speed bump 303. Conversely, the wheel 301 experiences a sudden increase 309 in the speed when leaving the speed bump 303.

The amplitude of the deviation (wavelet amplitude) is a measure of the depth of the pothole 302 or the height of the speed bump 303, and the number of pulses between driving into/onto and leaving corresponds to a distance which represents the length of the pothole.

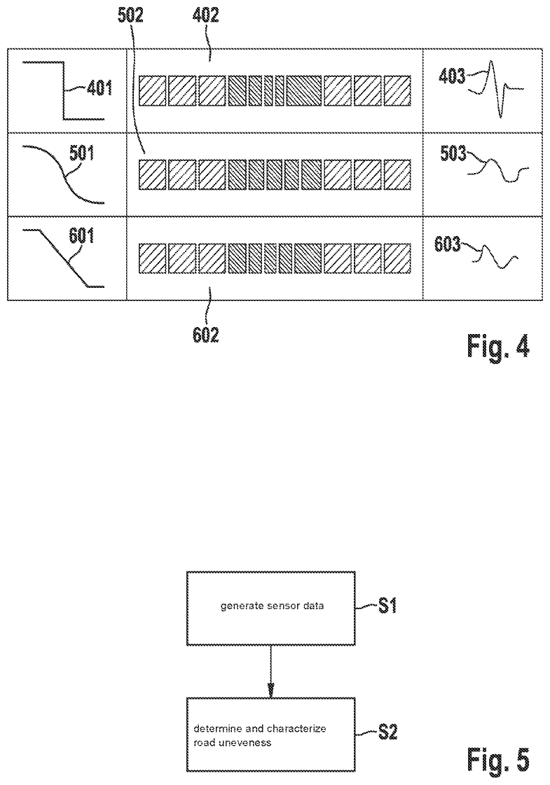

FIG. 4 shows schematic profiles of wheel speeds and accelerations for various edge shapes, namely, a steep edge 401, a rounded edge 501, and a ramp 601. Furthermore, the corresponding signal profile 402 of the wheel speed sensor 103 and the signal profile 403 of the acceleration sensor 103 for the steep edge are shown, as are the corresponding signal profiles 502 and 503 for the rounded edge and the signal profiles 602, 603 for the ramp. The signal profiles each show a characteristic form which can be detected, for example, by pattern detection (e.g., by a machine learning model and/or statistical model) or by comparison to threshold values.

FIG. 5 shows a flow chart of a method for determining and characterizing road unevenness. The method can be carried out using the device 1 described above. Conversely, the device 1 can be designed to carry out the method steps described below.

In a first method step S1, sensor data are generated by at least one wheel speed sensor 103 and/or at least one wheel-specific acceleration sensor 103 of a motor vehicle 101 driving on the roadway.

In a second method step S2, using the generated sensor data, an arithmetic unit 3 determines and characterizes a road unevenness. For this purpose, the arithmetic unit 3 can determine a time profile of the wheel speed. At the beginning of the road unevenness, the arithmetic unit 3 can in particular calculate a temporal change in the wheel speed. If the latter exceeds a threshold value, the road unevenness is detected. Furthermore, the arithmetic unit 3 determines the edge shape of the road unevenness.

The arithmetic unit 3 can also calculate and use a frequency behavior of the wheel speed in order to determine and characterize the road unevenness.

Furthermore, it can be provided that a road unevenness is detected if a change in the vertical acceleration of a wheel exceeds a specified threshold value.

The road unevenness is determined using a model algorithm which can comprise processing the raw sensor data as input, determining the instantaneous high-frequency wheel speed, and monitoring this wheel speed.

Furthermore, on the basis of a first change in the wheel speed, the arithmetic unit 3 can detect driving onto the road unevenness and, on the basis of a second change in the wheel speed, the arithmetic unit can detect leaving the road unevenness.

By taking into account the vehicle speed, the length of the road unevenness can be determined by determining the number of pulses in the time period between driving onto and leaving the road unevenness.

Furthermore, the depth of the road unevenness can be determined, for example by determining the amplitude of the change in the wheel speed. The depth is, for example, proportional to the amplitude or can be learned on the basis of a calibration.

Furthermore, a width can be determined, for example by detecting whether the road unevenness is detected at each wheel or only at particular wheels.

The road unevenness can also take place using a machine learning model and/or statistical model.

Furthermore, the information regarding the road unevenness can be output to a cloud. On the basis of this information, a geographical map can be created in which the road unevenness is recorded.

Determining the road unevenness can take place in the vehicle, for example by calculation in a control unit of an anti-lock brake system of the motor vehicle 101. However, determining the road unevenness can also take place at least partially outside the motor vehicle 101, for example in the cloud.

1-10. (canceled)

11. A method for determining and characterizing road unevenness of a roadway, comprising the following steps:
generating sensor data using at least one wheel speed sensor and/or at least one wheel-specific acceleration sensor of a motor vehicle driving on the roadway; and
determining and characterizing the road unevenness by an arithmetic unit using the generated sensor data, wherein the characterizing of the road unevenness includes determining an edge shape of the road unevenness.

12. The method according to claim 11, wherein the wheel speed sensor senses pulses as a function of a movement of a pulse wheel arranged on a wheel of the motor vehicle, wherein the arithmetic unit determines an angular profile of a wheel speed based on changes in the sensed pulses as a function of time, and wherein the arithmetic unit determines the edge shape based on the determined angular profile of the wheel speed.

13. The method according to claim 12, wherein the arithmetic unit determines a road unevenness when a magnitude of an angular change in the wheel speed exceeds a first threshold value and determines the edge shape by comparing the magnitude of the angular change in the wheel speed to at least a second threshold value.

14. The method according to claim 11, wherein the sensor data of the at least one wheel-specific acceleration sensor includes a vertical acceleration of the wheel, and wherein the arithmetic unit determines the edge shape of the road unevenness as a function of a time profile of the vertical acceleration.

15. The method according to claim 14, wherein the arithmetic unit determines the road unevenness when a magnitude of the vertical acceleration exceeds a first threshold value and determines the edge shape by comparing the magnitude of the vertical acceleration to at least a second threshold value.

16. The method according to claim 11, wherein the arithmetic unit calculates a frequency behavior of a wheel speed and/or a vertical acceleration of a wheel based on the generated sensor data, and wherein the arithmetic unit determines the edge shape of the road unevenness based on the calculated frequency behavior of the wheel speed and/or the vertical acceleration of the wheel.

17. The method according to claim 11, wherein the arithmetic unit determines the edge shape of the road unevenness using a machine learning model and/or statistical model which receives input data dependent on the sensor data.

18. The method according to claim 11, wherein the arithmetic unit is an arithmetic unit external to the motor vehicle; and wherein the sensor data are output to the arithmetic unit via an interface of the motor vehicle.

19. The method according to claim 11, wherein the arithmetic unit is a control unit of an anti-lock brake system of the motor vehicle.

20. A device for determining and characterizing road unevenness of a roadway, comprising:
an interface configured to receive generated sensor data from at least one wheel speed sensor and/or at least one wheel-specific acceleration sensor of a motor vehicle driving on the roadway; and
an arithmetic unit configured to determine and characterize the road unevenness using the generated sensor data, wherein the characterizing of the road unevenness includes determining an edge shape of the road unevenness.
